(19) United States
(12) Patent Application Publication
(10) Pub. No.: US 2008/0168867 A1
(43) Pub. Date: Jul. 17, 2008

(54) Apparatus for fastening screw-threaded cable connections

(76) Inventor: Stefan Reker, Bielefeld (DE)

Correspondence Address: LAUBSCHER & LAUBSCHER, P.C., 1160 SPA ROAD, SUITE 2B, ANNAPOLIS, MD, 21403, US

(21) Appl. No.: 12/006,358

(22) Filed: Jan. 2, 2008

(30) Foreign Application Priority Data
Jan. 12, 2007 (DE) 20 2007 000 453.2

(51) Int. Cl. H02G 1/14; B25B 13/48; B25B 21/00; B25B 13/28; H01R 43/26

(52) U.S. Cl. 81/99; 81/54

(57) ABSTRACT

A tool is provided for rotating a locking sleeve that is concentrically mounted on a plug between locked and unlocked conditions relative to a socket to which the plug is connected, including a tool body containing a recess within which is rotatably supported a driving disk, and a clamping arrangement that clamps the tool body to the locking sleeve such that a circumferential portion of the driving disk protrudes outwardly from the recess into frictional engagement with the peripheral surface of the locking sleeve. Consequently, upon rotation of the driving disk by an operating shaft, the locking sleeve is rotated relative to the socket.

### BACKGROUND OF THE INVENTION

1. Field of the Invention

A tool is provided for rotating a locking sleeve that is concentrically mounted on a plug between locked and unlocked conditions relative to a socket to which the plug is connected, including a tool body containing a recess within which is rotatably supported a driving disk, and a clamping arrangement that clamps the tool body to the locking sleeve such that a circumferential portion of the driving disk protrudes outwardly from the recess into frictional engagement with the peripheral surface of the locking sleeve. Consequently, upon rotation of the driving disk by an operating shaft, the locking sleeve is rotated relative to the socket.

2. Description of Related Art

As indicated by the Drews U.S. Pat. No. 6,883,403. it is well known in the prior art to provide tools for rotating a screw-threaded locking sleeve on a plug member relative to a screw-threaded socket body to which the plug is connected.

The known tools have a seat or opening in which a screw-threaded cable locking device is enveloped about half way and is retained firmly by a clamping element. After the cable screw connection has been clamped firmly, the entire tool is turned around the axis of the cable screw connection so that the cable screw connection will be tightened or loosened depending on the direction of rotation.

As a driving tool, one uses here a device that resembles a screwdriver which is inserted in the driver opening and which, here, can be turned for the purpose of actuating the clamping element. The cable screw connection is tightened or loosened not by rotating the driving tool around its longitudinal axis, but rather by swinging the entire tool plus the driving tool around the longitudinal axis of the seat defined within the clamping means.

This operation requires the assembler to have a certain level of skill and can also be done manually. The present invention was developed to provide a tool of the typical kind which on the whole will be simpler to operate, and which also can possibly be driven by a motor.

### SUMMARY OF THE INVENTION

Accordingly, a primary object of the present invention is to provide a tool for rotating a threaded locking sleeve mounted on a plug member that is electrically connected with a socket member, including a tool body that is clamped to the locking sleeve, a driving disk rotatably mounted in a recess contained in the tool body and protruding from the recess into circumferential frictional engagement with the locking sleeve, and means for rotating the driving disk, thereby to threadably connect the locking sleeve to the socket, and to lock together the plug and socket members.

According to a more specific object of the invention, at least the circumferential portion of the driving disk is formed from a resilient synthetic plastic or rubber material. In order to increase the frictional engagement between the driving disk and the peripheral surface of the locking sleeve, the circumferential surface of the driving disk may be knurled. Furthermore, disk spring means may be provided for biasing the driving disk laterally relative to the tool body toward the locking sleeve.

A more specific object of the invention is to provide clamping means for claming the rotating tool to the locking sleeve, including at least one clamping arm that is pivotally connected with the tool body for displacement between clamped and open positions. Clamping arm spring means may be provided for biasing the clamping arm toward the clamped position relative to the tool body. A plurality of rolling bodies mounted on the surface of each clamping arm are biased by rolling body spring means into engagement with the peripheral surface of the locking sleeve.

According to the present invention the clamping arms enclose a tubular screw-threaded locking sleeve completely or almost completely after they have been placed against it; moreover the driver opening for a driving tool is rotatably positioned in the tool and a drive disk that slightly protrudes into the seat, whereby the area of the drive disk that protrudes into the clamping opening rests in a friction-locking and/or form-locking manner upon a locking sleeve that is located in the seat.

This design feature makes it possible to tighten or loosen a cable screw connection exclusively by rotating the driving tool around its longitudinal axis, depending upon the direction of rotation, as a result of which one especially achieves the advantage that the driving disk can also be driven by a motor, for example, by a battery powered screwdriver. When the rotary tool of the present invention is used, it is thus no longer necessary to turn the tool and thus also the driving tool around the longitudinal axis of the clamping opening. This also signifies a simplification of the manual actuation of the tool by means of an actuation device that is like a screwdriver. After it has been placed in engagement with a locking sleeve, the tool can be actuated only by rotating the driving tool around its own longitudinal axis; therefore, both the tightening and the loosening actions can be performed in one working step and there is no longer any need to shift the tool around with relation to the locking sleeve, such as this is still the case with the currently known tools.

To create optimum contact between the drive wheel and the cable screw connection, it is advantageous when the driving disk can be shifted—and will be spring-loaded—laterally with respect to its longitudinal axis in the direction of the seat. In this way, one can, on the one hand, readily adjust any tolerances and, on the other hand, one can also make sure that the driving disk will always apply an optimum compression pressure upon the outer periphery of the locking sleeve.

Preferably, at least the circumferential area of the drive wheel is made of elastic material, preferably a synthetic plastic material or rubber. As a result, one can prevent undesirable deformations of the drive wheel and/or of the locking sleeve connection even when the tolerance conditions are unfavorable. As a rule, locking sleeves are provided on their outer surfaces with knurling; it is therefore particularly advantageous when the drive wheel, on its circumference, is provided with knurling that will then correspond to the knurling of a cable screw connection. In this way, one can definitely improve the driver effect as the driving disk is turned. This presents another advantageous feature of the invention: namely, that in the area of the clamping opening or seat, along the outer peripheral surface of the locking sleeve, there are provided guide body means that rest against the periphery of the locking sleeve in a supporting manner and that come in the form of spheres and/or rollers.

Consequently, one can prevent or reduce friction forces between the outer circumference of a cable screw connection and the inside sheath of the seat, so that a cable screw connection can be easily tightened or loosened by means of the drive wheel.

### BRIEF DESCRIPTION OF THE DRAWINGS

Other objects and advantages of the invention will become apparent from a study of the following specification, when viewed in the light of the accompanying drawing, in which:

FIG. 1 is a top perspective view illustrating the manner of operation of the tool of the present invention to lock or unlock the locking sleeve of an electrical connector arrangement; and

FIG. 2 is a top plan view of the sleeve rotating tool of the present invention.

### DETAILED DESCRIPTION OF THE INVENTION

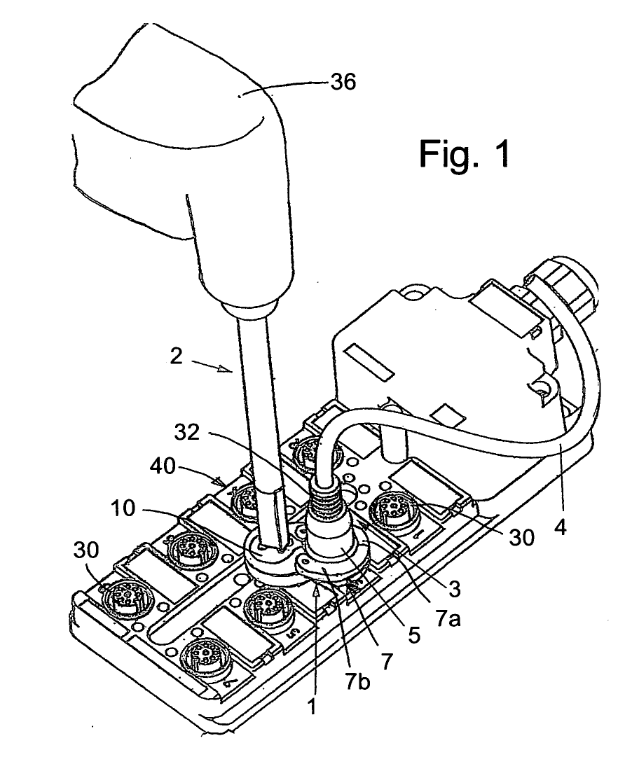

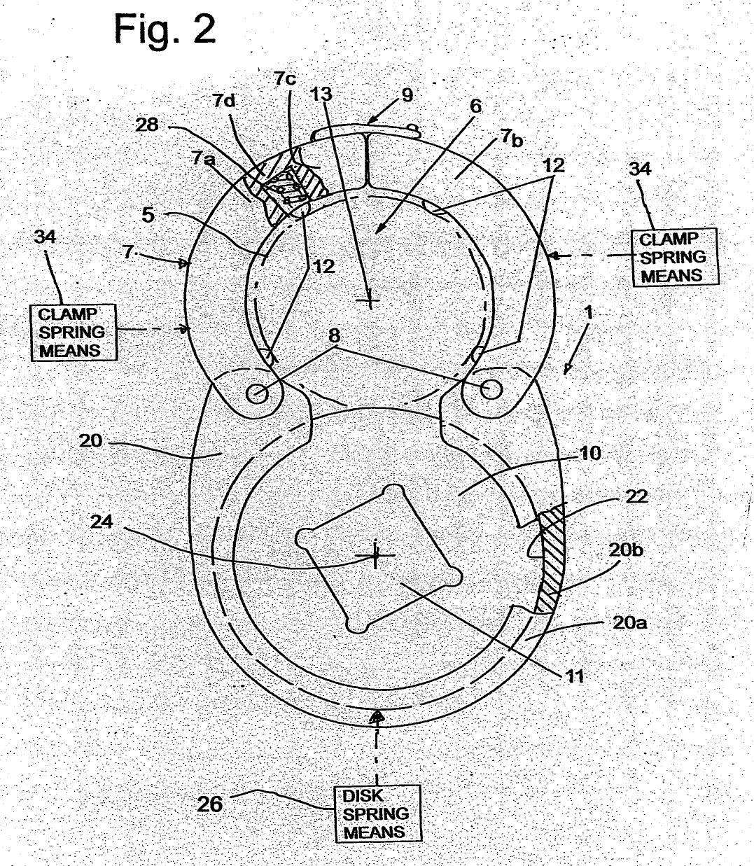

Referring first more particularly to FIG. 1, the sleeve rotating tool 1 of the present invention is operable to rotate relative to the externally threaded cylindrical body of a socket member 30 an internally threaded locking sleeve 5 that is rotatably mounted on a plug member 32 that is electrically connected with the socket member. In the illustrated embodiment, a plurality of the socket members 30 are mounted on a support housing 40 for connection with a plurality of plug members each having a cable 4 connected thereto, and a concentrically arranged generally tubular locking sleeve 5. The tool 1 includes a tool body 20 that is clamped to the locking sleeve 5 by clamping means 7. As will be described in greater detail below with reference to FIG. 2, a driving disk 10 is rotatably supported in a recess 22 contained in the tool body, which driving disk has a circumferential portion that is in frictional engagement with the outer peripheral surface of the locking sleeve 5. Thus, upon rotation of the driving disk by a tool shaft 2 that is rotatably driven by the reversible electric motor 36, the locking sleeve may be rotated in either the locking or the unlocking direction relative to the threaded body portion of the socket member 30.

As shown in FIG. 2, the sleeve rotating tool 1 includes a rigid body 20 containing a recess 22 in which is mounted for rotation about its central axis 24 a circular driving disk 10 containing a central non-circular opening 11. Clamping means 7 are provided for clamping the tool body 20 to the outer peripheral surface of a locking sleeve 5 that is rotatably mounted on a plug member 32 that is electrically connected with a socket member 30. These clamping means include a pair of clamping arms 7a and 7b that are connected at one end with the tool body 20 by pivot pins 8 for pivotal movement about axes parallel with the tool body central axis 24. The clamping arms have generally semicircular configurations to define a circular opening or seat 6 for receiving the locking sleeve 5. Disk spring means 26 bias the driving disk 10 relative to the tool body 20 laterally toward the clamping means 7, thereby to cause the circumferential surface of the driving disk to extend into frictional engagement with the outer peripheral surface of the locking sleeve 5. Preferably, at least the circumferential portion of the driving disk is formed from a resilient synthetic plastic or rubber material. In order to increase the frictional engagement between the driving disk and the peripheral surface of the locking sleeve, the outer circumferential surface of the driving disk may be knurled. Manually operable clasp means 9 serve to fasten the free ends of the clamping arms together when the arms are in the illustrated clamping condition.

In order to support the locking sleeve for rotation by the driving disk 10, the inner circumference of the clamping means 7 is circumferentially spaced from the outer peripheral surface of the locking sleeve 5, thereby to permit circular rolling body members 12, such as balls or rollers, moveably mounted in the adjacent surfaces of the clamping arms, to be biased by compression springs 28 radially inwardly toward engagement with the outer peripheral surface of the locking sleeve 5. Clamp member spring means 34, such as torsion springs arranged concentrically about the pivot pins 8, may be provided for biasing the clamping arms together to cause the rolling body members to engage the outer peripheral surface of the locking sleeve 5.

As shown in FIG. 2, the tool body 20 preferably is laminated and includes an outer cover layer 20a that covers an inner layer 20b that contains the recess 20 that receives the driving disk 10. Similarly, the clamping arms include cover layers 7c that cover the layer 7d containing the recesses that receive the ball or roller compression biasing springs 28.

### Operation

In operation, assume that a electrical plug member 32 is connected with a socket member 30, as shown in FIG. 1. In order to threadably connect the locking sleeve 5 to the threaded body portion of the socket member 30, the catch means 9 are in the unlocked condition, and the clamping arms 7a and 7b are pivoted outwardly apart, whereupon the rotating tool is displaced to cause the sleeve 5 to be received in the space 6 between the clamping arms. The clamping arms are released and are biased together by the clamp arm spring means 34, thereby to cause the ball or roller members 12 to come into engagement with the locking sleeve 5. The free ends of the clamping arms are then fastened together by the clasp means 9, thus to assure that the circumferential portion of the driving disk 10 that protrudes from the recess 22 is in frictional engagement with the outer peripheral surface of the locking sleeve. The non-circular pointed end of the tool shaft 2 (such as the head of a Phillips screwdriver, for example) is inserted into the corresponding non-circular central opening 11 in the driving disk. The electric motor 36 is then operated in a direction causing the locking sleeve 5 to be rotatably driven by the driving disk 10 in a direction to threadably connect the locking sleeve to the socket 30, and thereby lock the plug to the socket. The tool 2 is removed from the driving disk 10, whereupon the clasp is opened, the clamping arms are separated against the restoring force of the spring means 30, and the rotating tool is removed from the locking sleeve.

In order to unlock the sleeve, the clamping arms are separated to permit entry of the locking sleeve therebetween, whereupon the clamping arms are displaced together to effect engagement between the rolling body members 12 and the locking sleeve 5, and the free ends of the clamping arms are connected together by the clasp means 9. The tip of the shaft 2 is inserted into the opening 11, and the electric motor 36 is operated in the opposite direction, thereby to unlock the sleeve from the socket.

While in accordance with the provisions of the Patent Statutes the preferred forms and embodiments of the invention have been illustrated and described, it will be apparent to those skilled in the art that changes may be made without deviating from the invention described above.

What is claimed is:

1. A sleeve rotating tool for connecting to a screw-threaded socket member (30) a screw-threaded tubular locking sleeve (5) that is rotatably mounted on an associated plug member (32), comprising:
(a) a tool body (20) containing a recess (22);
(b) a circular driving disk (10) mounted in said recess for rotation about a given disk axis (24), a circumferential portion of said driving disk protruding radially outwardly from the opening of said recess;
(c) clamping means (7) for clamping said tool body to the locking sleeve such that:
(1) the axis (13) of the locking sleeve extends parallel with said disk axis, and
(2) the outer peripheral surface of said driving disk protruding portion is in frictional engagement with the peripheral surface of the locking sleeve; and
(d) disk drive means (11) for rotating said driving disk in opposite directions relative to said tool body, whereby when the plug member is electrically connected with said socket member, the locking sleeve is rotated by said driving disk between unlocked and locked conditions, and between locked and unlocked conditions, respectively, relative to the socket member.

2. A sleeve rotating tool as defined in claim 1, and further including disk spring means (26) biasing said driving disk from said tool body toward said clamping means, thereby to bias said driving disk toward engagement with the peripheral surface of the locking sleeve.

3. A sleeve rotating tool as defined in claim 1, wherein at least the circumferential portion of said driving disk is formed from an elastic synthetic plastic material.

4. A sleeve rotating tool as defined in claim 3, wherein the circumferential surface of said driving disk is knurled.

5. A sleeve rotating tool as defined in claim 1, wherein said clamping means includes a plurality of rotatably mounted rolling bodies (12) arranged in circumferentially spaced relation for engagement with the outer peripheral surface of the locking sleeve.

6. A sleeve rotating tool as defined in claim 5, wherein each of said rolling bodies comprises a ball.

7. A sleeve rotating tool as defined in claim 5, wherein each of said rolling bodies comprises a roller.

8. A sleeve rotating tool as defined in claim 5, and further including a plurality of journal spring means (28) biasing said journal members from said clamping means radially inwardly toward the outer periphery of the locking sleeve.

9. A sleeve rotating tool as defined in claim 1, wherein said clamping means includes at least one generally semi-circular clamping arm (7a) pivotally connected at one end with said tool body for displacement about a pivot axis (8) parallel with said driving disk axis.

10. A sleeve rotating tool as defined in claim 9, wherein said clamping means includes a pair of said semicircular clamping arms (7a, 7b) each pivotally connected at one end with said tool body for displacement about a pivot axis (8) parallel with said driving disk axis, said clamping arms being pivotally displaceable between closed and open positions relative to the locking sleeve.

11. A sleeve rotating tool as defined in claim 10, and further including clamping arm spring means (34) biasing said clamping arms toward clamping engagement with the outer peripheral surface of the locking sleeve.

12. A sleeve rotating tool as defined in claim 10, and further including clasp means (9) for fastening said clamping arms together in the closed position.

13. Connector locking and unlocking apparatus as defined in claim 1, wherein said disk drive means comprises a rotating tool (2) having a shaft with a non-circular point that engages a non-circular central opening (11) contained in said driving disk.

14. A sleeve rotating tool as defined in claim 13, wherein said rotating tool includes a reversible electric motor (36).
